(19) United States
(12) Patent Application Publication
(10) Pub. No.: US 2019/0305289 A1
(43) Pub. Date: Oct. 3, 2019

(54) Battery With a Stabilized Cathode Active Material

(71) Applicant: Robert Bosch GmbH, Stuttgart (DE)

(72) Inventors: Sondra Hellstrom, East Palo Alto, CA (US); Saravanan Kuppan, Sunnyvale, CA (US); Ethan Huang, Hayward, CA (US); Thomas Eckl, Leonberg (DE); Benedikt Ziebarth, Pforzheim (DE)

(21) Appl. No.: 15/939,798

(22) Filed: Mar. 29, 2018

(51) Int. Cl. H01M 4/131; H01M 10/0525; H01M 4/134; H01M 4/36; H01M 4/505; H01M 4/525; H01M 4/52; H01M 10/615; H01M 10/63

(52) U.S. Cl. CPC H01M 4/131; H01M 10/0525; H01M 4/134; H01M 4/366; H01M 2300/0065; H01M 4/525; H01M 4/523; H01M 10/615; H01M 10/63; H01M 4/505

(57) ABSTRACT

A battery includes at least one battery cell having an electrode assembly. The electrode assembly includes a cathode layer that has a cathode active material and a matrix material. The electrode assembly further includes an anode layer and a separator layer interposed between the cathode and the anode. The cathode active material is stabilized, and the at least one battery cell is configured to be operated at a temperature that is greater than 45° C.

### TECHNICAL FIELD

This disclosure relates generally to a batteries, and, more particularly, to cathode materials for a battery.

### BACKGROUND

Unless otherwise indicated herein, the materials described in this section are not prior art to the claims in this application and are not admitted to the prior art by inclusion in this section.

In batteries, ions transfer between the negative electrode and positive electrode during charge and discharge cycles. For instance, when discharging, electrons flow from the negative electrode, through an external circuit, to the positive electrode to generate an electrical current in the external circuit. During this process, positive ions, for example lithium ions in a lithium-ion battery, travel within the battery from the negative electrode, through an electrolyte, to the positive electrode. Conversely, when charging, the external circuit supplies current that reverses the flow of electrons from the positive electrode, through the external charging circuit, and back to the negative electrode, while the positive ions move within the battery from the positive electrode through the electrolyte to the negative electrode.

Two important measures by which the performance of batteries are determined are the energy density of the battery, or the ratio of the energy stored to the volume or size of the battery, and the rate at which the battery can be charged or discharged. Solid-state Li-ion batteries can possess high energy densities (>400 Wh/kg) and very good safety properties. However, current solid-state Li-ion batteries suffer from low conductivity.

Increasing the temperature at which solid-state cells are operated can increase the conductivity in the solid-state cells because conductivity generally has a strong positive relationship with operating temperature. However, conventional batteries cannot be operated at temperatures above 45° C., because the batteries are thermodynamically unstable in their charged, or delithiated, state. Conventional batteries have a tendency to reduce, and/or lose oxygen, at elevated temperatures, and these reactions are generally exacerbated in the presence of electrolyte. Thus, conventional batteries operating at elevated temperatures are generally limited by poor cycle life due to reactions that can occur between the cathode and electrolytes.

Thus, an improved battery with greater energy density, less cathode degradation, and an improved cycle life would be desirable.

### SUMMARY

In a first embodiment, a battery includes at least one battery cell having an electrode assembly. The electrode assembly includes a cathode layer that has a cathode active material and a matrix material. The electrode assembly further includes an anode layer and a separator layer interposed between the cathode and the anode. The cathode active material is stabilized, and the at least one battery cell is configured to be operated at a temperature that is greater than 45° C.

In one embodiment, the cathode active material comprises layered transition-metal-oxide particles coated with a cobalt oxide.

In a further embodiment, the layered transition-metal-oxide particles comprise at least one of nickel-cobalt-manganese (“NCM”) and nickel-cobalt-aluminum (“NCA”).

In some embodiments of the battery, the cobalt oxide comprises Co₃O₄.

In yet another embodiment, the cobalt oxide includes between 80 and 100% Co₃O₄.

In certain embodiments of the battery, an average particle size of the cathode active material is greater than 1 micron.

In a further embodiment, the anode layer comprises lithium metal.

In some embodiments of the battery, the separator layer comprises a solid-state electrolyte.

Another embodiment of the battery further comprises a temperature management system that includes a heater configured to supply thermal heat to the at least one battery cell, and a controller operably connected to the heater and configured to operate the heater to maintain the temperature of the at least one battery cell greater than 45° C.

In another embodiment of the battery, the cathode active material comprises layered transition-metal-oxide particles doped with Mg²⁺.

In a further embodiment, the layered transition-metal-oxide particles comprise at least one of NCM and NCA.

In some embodiments, the cathode active material is between 0.002% and 20% atomic percentage of Mg²⁺.

In another embodiment, an average particle size of the cathode active material is greater than 1 micron.

In yet another embodiment, the anode layer comprises lithium metal.

In some embodiments, the separator layer comprises a solid-state electrolyte.

A further embodiment of a battery cell comprises an electrode assembly comprising a cathode layer that includes a cathode active material and a matrix material. The electrode assembly further includes an anode layer and a separator layer interposed between the cathode and the anode. The cathode active material is stabilized and the battery cell is configured to be operated at a temperature that is greater than 45° C.

In some embodiments, the cathode active material comprises layered transition-metal-oxide particles coated with a cobalt oxide, and the layered transition-metal-oxide particles comprise at least one of NCM and NCA.

In a further embodiment, the cobalt oxide includes between 80 and 100% Co₃O₄ and an average particle size of the cathode active material is greater than 1 micron.

In another embodiment of the battery cell, the cathode active material comprises layered transition-metal-oxide particles doped with Mg²⁺ and the layered transition-metal-oxide particles comprise at least one of NCM and NCA.

In one embodiment, the cathode active material is between 0.002% and 20% atomic percentage of Mg²⁺ and an average particle size of the cathode active material is greater than 1 micron.

### BRIEF DESCRIPTION OF THE DRAWINGS

FIG. 1 is a schematic perspective view of a battery pack configured for operation at elevated temperatures above 45° C.

FIG. 2 is a schematic view of an electrode configuration for the battery cells of the battery pack of FIG. 1.

FIG. 3 is a schematic view of a cathode active material and cathode matrix material of the electrode configuration of FIG. 2.

FIG. 4 is a schematic view of another cathode active material and cathode matrix material of the electrode configuration of FIG. 2.

### DETAILED DESCRIPTION

For the purposes of promoting an understanding of the principles of the embodiments described herein, reference is now made to the drawings and descriptions in the following written specification. No limitation to the scope of the subject matter is intended by the references. This disclosure also includes any alterations and modifications to the illustrated embodiments and includes further applications of the principles of the described embodiments as would normally occur to one skilled in the art to which this document pertains.

As used herein, the term “approximately” is used to refer to values that are within 10% of the reference value.

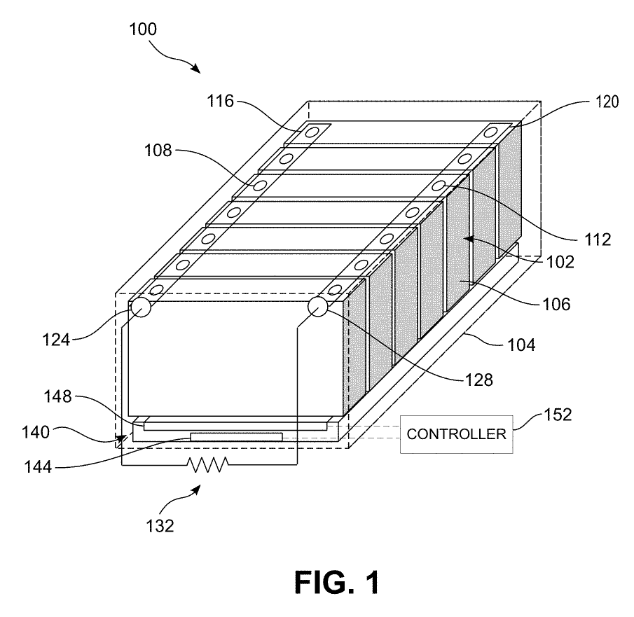

Referring to FIG. 1, a battery pack 100 includes a plurality of battery cells 102 arranged in a pack housing 104. Each of the battery cells 102 includes a cell housing 106, from which a positive terminal 108 and a negative terminal 112 are exposed. In a parallel arrangement, the positive terminals 108 may be connected to one another by a positive battery pack current collector 116, and the negative terminals 112 may be connected to one another by a negative battery pack current collector 120. In a series arrangement, the positive terminals 108 may be connected to adjacent negative terminals 112 by a battery pack current collector. The battery pack current collectors 116, 120 are connected to respective positive and negative battery pack terminals 124, 128, which connect to an external circuit 132 that may be powered by the battery pack 100, or may be configured to charge the battery pack 100.

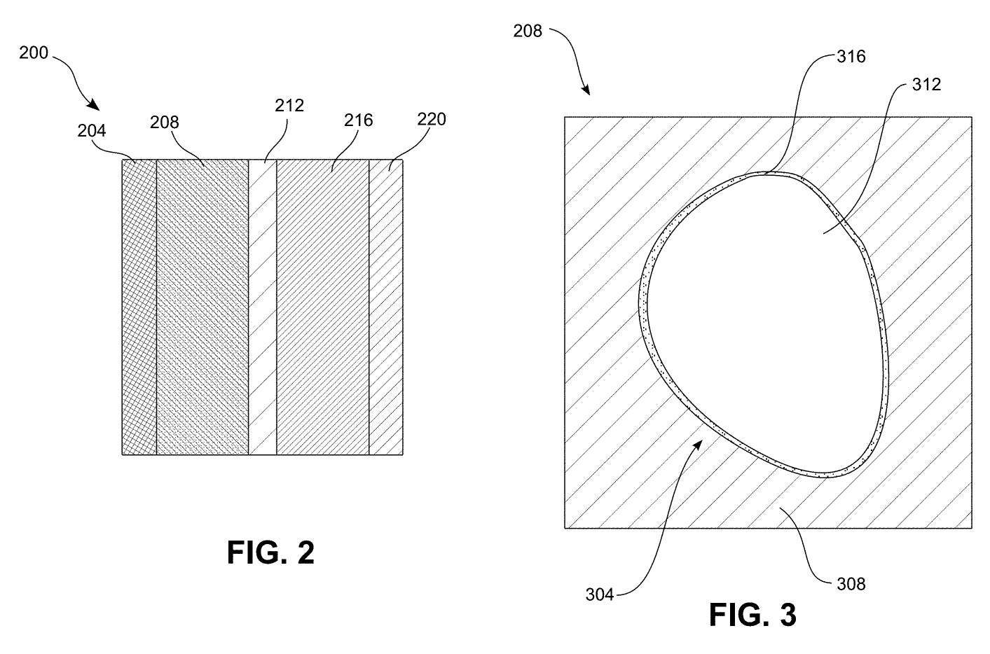

Each battery cell 102 includes an electrode configuration 200, illustrated in FIG. 2, which includes a cathode current collector 204, a cathode layer 208, a separator layer 212, an anode 216, and an anode current collector 220. In some embodiments, multiple layers of the electrode configuration 200 are stacked on top of one another so as to form an electrode stack. In other embodiments, the electrode configuration 200 is wound around itself in a spiral shape so as to form what is known as a “jelly-roll” or “Swiss-roll” configuration.

The cathode current collector 204 connects the positive terminal 108 of the battery cell 102 with the cathode 208 so as to enable flow of electrons between the external circuit 132 and the cathode 208. In one embodiment, the cathode current collector 204 is formed of aluminum foil, though other desired materials are used in other embodiments. In some embodiments, the cathode current collector 204 includes a surface treatment to improve conductivity of the cathode current collector 204 or to improve the corrosion resistance of the cathode current collector 204.

As seen in the schematic illustration of FIG. 3, the cathode 208 of the electrode configuration 200 comprises a mixture of a cathode active material 304 and a matrix 308 that conducts lithium ions and is compatible with elevated operating temperatures. In some embodiments, the matrix 308 includes a catholyte that includes: low-volatility liquid or gel electrolytes; polymeric electrolytes such as polyethylene oxide (PEO) or polycaprolactone (PCL); ceramic or glassy sulfidic or oxidic Li-ion conductors; or any desired combination of the above materials. Additionally, the matrix 308 may include one or more binders, lithium salts, plasticizers, fillers such as SiO₂, and the like. In some embodiments, the matrix 308 includes a carbon additive that improves the electrical conductivity of the matrix 308. In various embodiments, the cathode 208 can include between approximately 60-85% by weight of active material 304, between approximately 3-10% by weight of carbon additive in the matrix 308, and between approximately 15-35% by weight of the catholyte in the matrix 308.

The cathode active material 304 includes a layered transition-metal-oxide 312, for example nickel-cobalt-aluminum (“NCA”), which has the chemical formula LiNiₓCo_{y}Al_{z}O₂, nickel-cobalt-manganese (“NCM”), which has the chemical formula LiNiₓCo_{y}Mn_{z}O₂, another nickelate material, lithium-cobalt-oxide (“LCO”), which has the chemical formula LiCoO₂, or derivatives of one or more of the aforementioned materials. The layered transition-metal-oxide 312 is modified from its conventional form for improved long-term thermal, chemical, and/or electrochemical stability to enable the battery to operate at increased temperatures and with improved life cycle.

In the embodiment of FIG. 3, the particles of the layered transition-metal-oxide 312 are coated with a layer 316 of cobalt oxide. In one particular embodiment, the layered transition-metal-oxide is coated with a layer 316 that contains primarily Co₃O₄. For example, the layer 316 may include between 80% and 100% Co₃O₄ in one embodiment. In another embodiment, the layer 316 is between 95% and 100% Co₃O₄. In yet another embodiment, the layer 316 is between 99% and 100% Co₃O₄. In some embodiments, the cathode active material particles 304 are larger than conventional cathode active material particles and can have, for example, an average primary particle size or diameter that is greater than 1 micron.

The cobalt oxide coating layer 316 improves the stability of the cathode 204. In particular, cobalt is one of the more stable transition metals in a nickelate cathode active material. Thus, increasing the concentration of cobalt on the surface of the particles of layered transition-metal-oxide 312, where degradation of the cathode active material particles 304 occurs first and is typically most severe functions to slow down decomposition of the cathode active material particle 304. Additionally, the cobalt oxide coating layer 316 reduces the surface area of the cathode active material particles 304, which reduces microcracking of the cathode 208 and thus reduces degradation of the cathode 208 at elevated temperature.

Moreover, the presence of cobalt oxide, in particular a Co₃O₄ spinel, reduces or eliminates rock salt type oxides from forming on the surface of the cathode active material particles 304. In addition, the cobalt oxides, in particular, Co₃O₄ spinels, provide a more thermodynamically stable material than conventional delithiated nickelates. Thus, the cobalt oxides provide protection for the surface of the cathode active material 304 particles, while simultaneously enabling access to the full capacity of the cathode material.

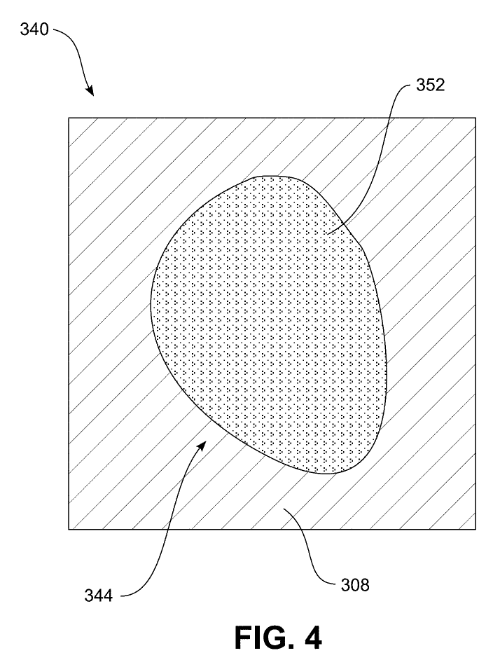

FIG. 4 is a schematic illustration of another cathode material 340 that is used in place of the cathode 208 in the electrode assembly of FIG. 2. Similarly to the embodiment of FIG. 3, the cathode 340 includes a matrix 308 and a cathode active material 344. The matrix 308 may be any of the materials discussed above with regard to the matrix material of FIG. 3.

The cathode active material 344 of the embodiment of FIG. 4 includes particles of layered transition-metal-oxides 352, which can again be NCA, NCM, other nickelates, LCO, or derivatives thereof. The layered transition-metal-oxide 352 is doped with Mg²⁺ ions such that some of the lithium ions in the layered transition-metal-oxide 352 are replaced with magnesium (Mg²⁺) ions. In some embodiments, the layered transition-metal-oxide 352 is doped throughout with Mg²⁺, while in other embodiments the doped Mg²⁺ is concentrated on the surface of the layered transition-metal-oxide particles 352. Since the degradation of the cathode active material particles 344 typically begins at the surface of the particles, a higher concentration of the doped magnesium can, in some instances, further reduce the degradation of the cathode active material 344.

In one embodiment, the magnesium doped cathode active material particles 344 are formed by adding the magnesium precursors, which can be, for example, magnesium oxide or magnesium nitrate, to the reactants in the initial solid-state synthesis. In another embodiment, the magnesium doped cathode active material particles 304 are formed by coating an unmodified cathode particle with a magnesium precursor and sintering the coated particle to dope the magnesium into the layered transition-metal-oxides 352.

In one embodiment, the overall atomic percentage of the magnesium in the doped cathode active material 344 is between approximately 0.002% and 20%. In another embodiment, the overall atomic percentage of the magnesium in the doped cathode active material 344 is between 1% and 5%. In some embodiments, the cathode active material particles 344 are larger than conventional cathode active material particles and can have, for example, an average primary particle size or diameter that is greater than 1 micron.

Returning to FIG. 2, the separator layer 212 is interposed between the cathode layer 208 and the anode layer 216 so as to isolate the layers 208, 216 from one another. The separator layer 212 may be, for example, a porous lithium-ion battery separator that can be filled with a liquid or gel electrolyte, or a solid electrolyte separator. The solid electrolyte separator may include one or more of: solid polymer electrolytes, a (block)-copolymer, and/or solid polyelectrolytes mixed with ceramics; a ceramic thin layer prepared, for example, by sputtering, such as lithium-phosphorus-oxynitride (“LiPON”); and a free-standing ceramic or glass ceramic layer such as lithium-aluminum-titanium-phosphate (“LATP”).

The anode layer 216 includes one or more of lithium metal, a copper mesh filled with lithium metal, a composite electrode that comprises a mixture of active material and a conductive matrix, and a graphitic lithium-ion battery anode. The anode active material may be, for example, one or more of lithium, Li₄Ti₅O₁₂, silicon, or intermetallic compounds. In various embodiments, the conductive matrix includes one or more of a solid polymer electrolyte and a solid polyelectrolyte, and may include nanowires and/or a carbon additive.

The anode current collector 220 connects the negative terminal 112 of the battery cell 102 with the anode 216 so as to enable flow of electrons between the external circuit 132 and the anode 208. In one embodiment, the anode current collector 220 is formed of copper foil, though other desired materials are used in other embodiments. In some embodiments, the anode current collector 220 includes a surface treatment to improve conductivity of the anode current collector 220 or to improve the corrosion resistance of the anode current collector 220.

When the battery pack 100 is connected to an external circuit 132 that is powered by the battery pack 100, lithium ions are separated from electrons in the anode 216. The lithium ions travel through the separator 212 and into the cathode 208. The free electrons in the battery create a positive charge in the battery, and then flow from the anode 216, through the anode current collector 220, to the negative terminals 112 of the battery cells 102. The electrons are then collected by the battery pack current collector 120 and transported to the battery pack terminal 128. The electrons flow through the external circuit 132 so as to provide electrical power the external circuit 132, and then pass through the positive battery pack terminal 124, through the positive battery pack terminal 116, and back into the battery cells 102 via the positive terminals 108, where the electrons are collected by the cathode current collector 204 and distributed into the cathode 208. The electrons returning to the cathode 208 associate with the lithium ions that have crossed the separator 212. Connecting the battery pack 100 to an external circuit that charges the battery pack 100 results in the opposite flow of electrons and lithium ions.

Internal resistance of the battery cells 102 causes heat to build up in the battery cells 102. In conventional batteries, the heat buildup is undesirable, as the batteries are designed to be operated at temperatures of less than 45° C. Operating conventional batteries at temperatures of greater than 45° C. exacerbates reactivity of materials in the cathode. In particular, conventional batteries have a tendency to reduce, and/or lose oxygen, at elevated temperatures, and these reactions are generally increased in the presence of electrolytes. In some conventional batteries, therefore, cooling systems are required to reduce the temperature of the batteries. Operating the batteries at reduced temperatures, however, causes reduced conductivity of the electrolytes in the batteries, which therefore reduces the energy density of the batteries.

In the battery cells 102, the cathode active materials 304, 344 are stabilized by the cobalt oxide coating 316 and the magnesium doping. As a result, operating the battery cells 102 at temperatures in excess of 45° C. causes minimal or no degradation of the cathode active materials 304, 344. Thus, the battery cells 102 can be operated at temperatures in excess of 45° C. In particular, in one embodiment, the battery cells 102 are designed and configured to be operated at temperatures between 45° C. and approximately 120° C. In another embodiment, the battery cells 102 are designed and configured to be operated at temperatures between approximately 65° C. and approximately 120° C. In yet another embodiment, the battery cells 102 are designed and configured to be operated at temperatures between approximately 75° C. and approximately 100° C.

The electrolytes in the battery cells 102, for example the electrolytes in the cathode 208, the separator 212, and/or the anode 216, are more conductive at higher temperatures. Thus, operating the battery cells 102 at higher temperatures improves the conductivity within the battery cells 102. As a result of the improved conductivity, the battery cells 102 having the stabilized cathode active materials 304, 344 can be charged more quickly than would be possible at ambient temperature. Moreover, the power metrics of the battery cells 102, including the energy density, are improved at elevated temperatures.

In some embodiments, the battery pack 100 includes a temperature management system 140 to maintain the elevated temperature of the battery cells 102. The temperature management system 140 may include, for example, a heater 144, a cooling system 148, and at least one battery cell temperature sensor (not shown) configured to sense the temperature of at least one of the battery cells 102. In some embodiments, the temperature management system may include only one of a heater 144 or a cooling system 148. In one embodiment, the temperature management system 144 is controlled by a controller 152, which is operably connected to the heater 144, the cooling system 148, and/or the battery cell temperature sensor.

Operation and control of the heater 144 and/or cooling system 148 is performed with the aid of the controller 152. The controller 152 is implemented with general or specialized programmable processors that execute programmed instructions. The instructions and data required to perform the programmed functions are stored in the memory unit associated with the control unit. The processors, the memory, and interface circuitry configure the controller 152 to operate the heater 144 and/or the cooling system 148 to maintain the battery at a desired temperature or within a desired temperature range. The processors, the memory, and interface circuitry components can be provided on a printed circuit card or provided as a circuit in an application specific integrated circuit (ASIC). Each of the circuits can be implemented with a separate processor or multiple circuits can be implemented on the same processor. Alternatively, the circuits can be implemented with discrete components or circuits provided in VLSI circuits. The circuits described herein can also be implemented with a combination of processors, ASICs, discrete components, or VLSI circuits.

In one embodiment, the controller 152 is programmed to operate the heater 144 and/or the cooling system 148 based on the at least one battery cell temperature sensor to maintain the temperature of the battery in excess of 45° C. In particular, in one embodiment, the controller 152 is programmed to operate the heater and/or the cooling system 148 to maintain the temperature of the battery cells 102 between 45° C. and approximately 120° C. In another embodiment, the controller 152 is programmed to operate the heater and/or the cooling system 148 to maintain the temperature of the battery cells 102 between approximately 65° C. and approximately 120° C. In yet another embodiment, the controller 152 is programmed to operate the heater and/or the cooling system 148 to maintain the temperature of the battery cells 102 between approximately 75° C. and approximately 100° C.

It will be appreciated that variants of the above-described and other features and functions, or alternatives thereof, may be desirably combined into many other different systems, applications or methods. Various presently unforeseen or unanticipated alternatives, modifications, variations or improvements may be subsequently made by those skilled in the art that are also intended to be encompassed by the foregoing disclosure.

1. A battery comprising:
at least one battery cell having an electrode assembly comprising:
a cathode layer comprising a cathode active material and a matrix material, the cathode active material including layered transition-metal-oxide particles doped with Mg²⁺ such that lithium ions in the layered transition-metal-oxide structure are replaced with the Mg²⁺;
an anode layer; and
a separator layer interposed between the cathode layer and the anode layer,
wherein the cathode active material is stabilized by the Mg²⁺ doping such that the at least one battery cell is configured to be operated at a temperature that is greater than 45° C.

2-6. (canceled)

7. The battery of claim 1, wherein the anode layer comprises lithium metal.

8. The battery of claim 1, wherein the separator layer comprises a solid-state electrolyte.

9. The battery of claim 1, further comprising:
a temperature management system comprising:
a heater configured to supply thermal heat to the at least one battery cell; and
a controller operably connected to the heater and configured to operate the heater to maintain the temperature of the at least one battery cell between 65° C. and 120° C.

10. (canceled)

11. The battery of claim 1, wherein the layered transition-metal-oxide particles comprise at least one of nickel-cobalt-manganese (“NCM”) and nickel-cobalt-aluminum (“NCA”).

12. The battery of claim 11, wherein the cathode active material is between 0.002% and 20% atomic percentage of Mg²⁺.

13. The battery of claim 11, wherein an average particle size of the cathode active material is greater than 1 micron.

14-15. (canceled)

16. A battery cell comprising:
an electrode assembly comprising:
a cathode layer comprising a cathode active material and a matrix material, the cathode active material including layered transition-metal-oxide particles doped with Mg²⁺ such that lithium ions in the layered transition-metal-oxide structure are replaced with the Mg²⁺;
an anode layer; and
a separator layer interposed between the cathode layer and the anode layer,
wherein the cathode active material is stabilized by the Mg²⁺ doping such that the battery cell is configured to be operated at a temperature that is greater than 45° C.

17-18. (canceled)

19. The battery cell of claim 16, wherein the layered transition-metal-oxide particles comprise at least one of nickel-cobalt-manganese (“NCM”) and nickel-cobalt-aluminum (“NCA”).

20. The battery cell of claim 19, wherein:
the cathode active material is between 0.002% and 20% atomic percentage of Mg²⁺; and
an average particle size of the cathode active material is greater than 1 micron.

21. The battery of claim 1, wherein the layered transition-metal-oxide particles are doped with a higher concentration of the Mg²⁺ at an outer surface of the layered transition-metal-oxide particles than inside the layered transition-metal-oxide particles.

22. The battery of claim 21, wherein the layered transition-metal-oxide particles comprise nickel-cobalt-aluminum (“NCA”).

23. The battery cell of claim 16, wherein the layered transition-metal-oxide particles are doped with a higher concentration of the Mg²⁺ at an outer surface of the layered transition-metal-oxide particles than inside the layered transition-metal-oxide particles.

24. The battery cell of claim 23, wherein the layered transition-metal-oxide particles comprise nickel-cobalt-aluminum (“NCA”).

25. The battery of claim 21, wherein the cathode active material contains between 1% and 5% atomic percentage of Mg²⁺.

26. The battery of claim 1, wherein the battery is configured to be operated at a temperature that is between 65° C. and 120° C.

27. The battery cell of claim 23, wherein the cathode active material contains between 1% and 5% atomic percentage of Mg²⁺.

28. The battery cell of claim 16, wherein the battery cell is configured to be operated at a temperature that is between 65° C. and 120° C.
